(19) United States
(12) Patent Application Publication
(10) Pub. No.: US 2019/0158287 A1
(43) Pub. Date: May 23, 2019

(54) SYSTEMS AND METHODS FOR ASSURING MULTILATERAL PRIVACY

(71) Applicant: Paulo Menegusso, Tempe, AZ (US)

(72) Inventor: Paulo Menegusso, Tempe, AZ (US)

(21) Appl. No.: 15/821,667

(22) Filed: Nov. 22, 2017

(51) Int. Cl. H04L 9/32; G06F 21/60; H04L 9/30; H04L 9/08

(52) U.S. Cl. CPC H04L 9/321; G06F 21/602; H04L 9/30; G06Q 50/265; H04L 9/0894; G06F 2221/2115; H04L 9/0838

(57) ABSTRACT

A system and method are provided in which parties to a private agreement create a digital object and keep it private thereafter, while ensuring the ability to disclose this same digital object under specific and exceptional circumstances. The digital object can include one or more of a document, an audio recording, a video recording, and information collected using electronic forms, or by a preference-matching algorithm that reconciles default preferences and/or offers a way for the parties to negotiate preferences.

### BACKGROUND OF THE INVENTION

### 1. Field of the Invention

The present invention relates to systems and methods for assuring multilateral privacy.

### 2. Description of the Related Art

There are certain situations where compliance with what constitutes privately agreed upon conduct can be difficult or impossible to ascertain after the fact. For example, let us consider the quandary faced by parties A and B if they decide to engage in sexual intercourse after meeting each other at a party. While it is in their mutual interest to keep the act private, in accordance with social norms, it is also in their interest that they both behave in accordance with agreed upon norms concerning manner of play, “roughness,” safe words used, etc., which in a private setting is difficult to enforce. Let us now suppose that at a later time, A accuses B of rape. This may be a situation devoid of much objective evidence to either prove B's guilt or vindicate B's protestations of innocence. In such cases, often the result is an undesirable outcome of 1) an unreported rape, deterred by the daunting prospects of proving guilt and the inevitable public scrutiny, and/or 2) the tarnished reputation of one unjustly accused, given that removing the pall of suspicion about something that may have happened in private also faces high to impossible hurdles of objective counterarguments.

Furthermore, there are many other situations where parties to an agreement would like to keep the agreement in private, but also maintain the possibility of disclosure. This is particularly true whenever the parties to an agreement would like to forgo the bureaucracy of a formal contract involving lawyers and courts, such as in the preliminary stages of a negotiation.

### SUMMARY OF THE INVENTION

The present disclosure relates to a system and method by which parties enter into a private agreement while ensuring the ability to disclose the agreement only under specific and exceptional circumstances.

In an embodiment, the parties create a digital object that can include one or more of a document, an audio recording, a video recording, information collected using electronic forms, and so forth, having information regarding the terms of the agreement and its execution. Creation of the digital object can be generated by a software application in one of the party's computing device, typically a smartphone or a tablet, which also can capture information pertaining to the agreement, such as each party's consent, identification information of each of the parties, device location of the encrypted digital object, selection of a third party arbitrator, and the circumstances under which the encrypted digital object may be decrypted later. Files that are created on a computing device can be immediately encrypted using a public key provided by a Trusted Authority. In some implementations, the parties are able to preview the digital object before it is encrypted. In this case, the preview allows the user to decide to encrypt the digital object or to create it again. In an embodiment, the Trusted Authority securely stores the encrypted digital object and will decrypt it and distribute it to the parties only at the request of both of the parties or to a third party where a condition mutually agreed upon by the parties occurs. Decryption occurs using a private key known by the

Trusted Authority but not the parties. The decrypted information can be sent via a secured channel such as one using SSL or public key encryption wherein the public key generated by the receiver is used by the sender (Trusted Authority) to encrypt and a private key known by the receiver is used to decrypt, for example. In another embodiment, decryption is enabled by three keys: one for each party A and B, which can only function concomitantly, and one for a third party C, which can decrypt the digital object without the need for party A and/or B to be involved. Should later decryption prove necessary, it may be done by consent of parties A and B, who jointly apply their respective decryption keys, or it may be done unilaterally by the third party C, following procedures applicable to their respective jurisdictions. In another embodiment, the system employs pre-condition matching wherein mutual default preferences from party A and B are retrieved. If there are preferences that are not mutual, either party may accept the other party's preferences, though they need not do so. In yet another embodiment, the parties are able to negotiate preferences from lists of preferences, and accept mutually matched preferences. As with the above embodiments, the agreement is transformed into an encrypted digital object, and will be decrypted only upon consent of both parties or upon occurrence of one or more predetermined conditions, in which parties A and B, or the third party elected by them, will gain access to the decrypted digital object.

### BRIEF DESCRIPTION OF THE DRAWINGS

FIG. 1 illustrates an exemplary system for assuring multilateral privacy, according to an embodiment.

FIG. 2A illustrates a block diagram of an exemplary mobile device suitable for use by an individual user of the system for assuring multilateral privacy, according to an embodiment.

FIG. 2B illustrates a block diagram of an exemplary computer environment suitable for use by a Trusted Authority, according to an embodiment.

FIG. 3 illustrates a technique for pre-condition preference matching, according to an embodiment.

FIG. 4 illustrates a technique for negotiated preference matching, according to an embodiment.

FIG. 5 illustrates an exemplary process for a pair of individuals to be provided with partial private keys, both of which are necessary together to decrypt an encrypted digital object unless a predetermined condition is met, wherein the Trusted Authority can decrypt the encrypted digital object with its own private key, according to an embodiment.

FIG. 6 illustrates an exemplary process by which the individuals obtain a decrypted copy of the agreement, according to an embodiment.

FIG. 7 illustrates an exemplary process by which the Trusted Authority decrypts the encrypted digital object for a third party.

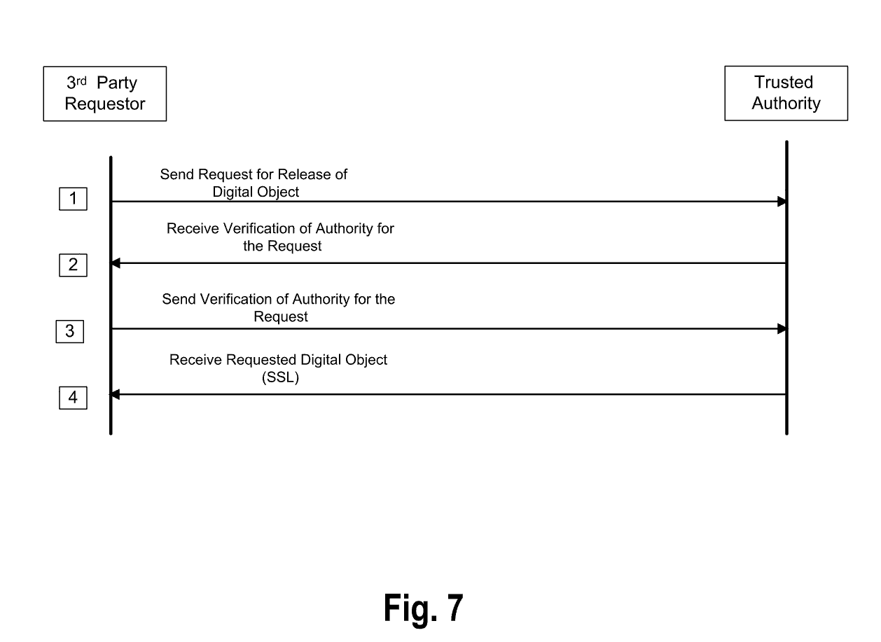

### DETAILED DESCRIPTION OF THE INVENTION

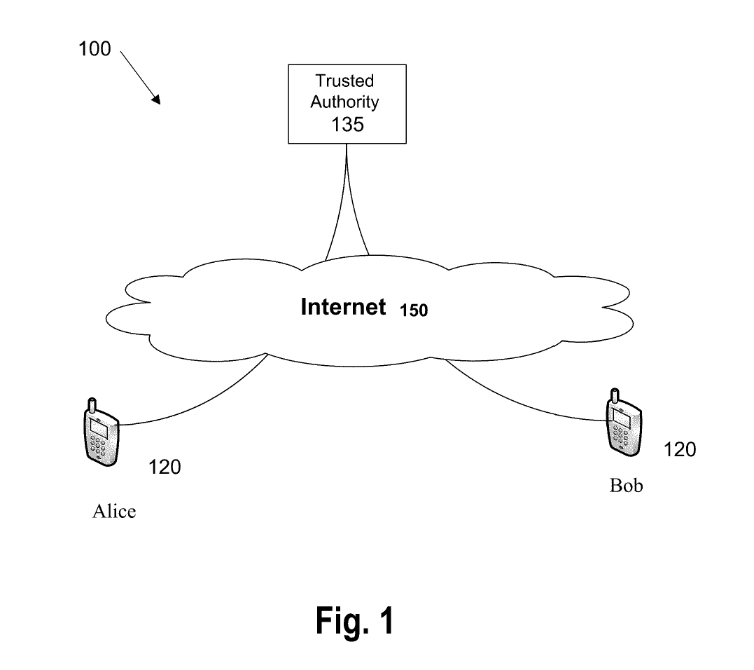

Referring to FIG. 1, an exemplary system for assuring multilateral privacy 100, according to an embodiment, is illustrated. As shown, the system 100 includes a plurality of computing devices 120 that are communicatively linked via the Internet 150 to a Trusted Authority 135. Each computing device 120 is preferably a mobile device such as a smartphone or a tablet computer, but can be any suitable computing device including a laptop computer or a desktop computer. As shown, there are two users Alice and Bob each having a respective computing device 120. However, it is to be understood that the system for assuring multilateral privacy 100 is capable of supporting many more such users. As will be described in greater detail, a plurality of users, such as Alice and Bob, enter into an agreement that they wish to keep secret except in exceptional circumstances. To this end, the system 100 prompts provision of information such as location of an encrypted digital object, selection of an arbiter, and the predetermined condition to allow the Trusted Authority 135 to decrypt the encrypted digital object. Using one of the computing devices 120 equipped with relevant software, one of the parties creates, or both parties together create, one or more of text, audio, and video files to memorialize the agreement that is encrypted to form the encrypted digital object. Should later decryption prove necessary, it may be done by consent of the parties Alice and Bob, or it may be done unilaterally by Trusted Authority 135, following procedures provided by the parties and applicable to their respective jurisdictions.

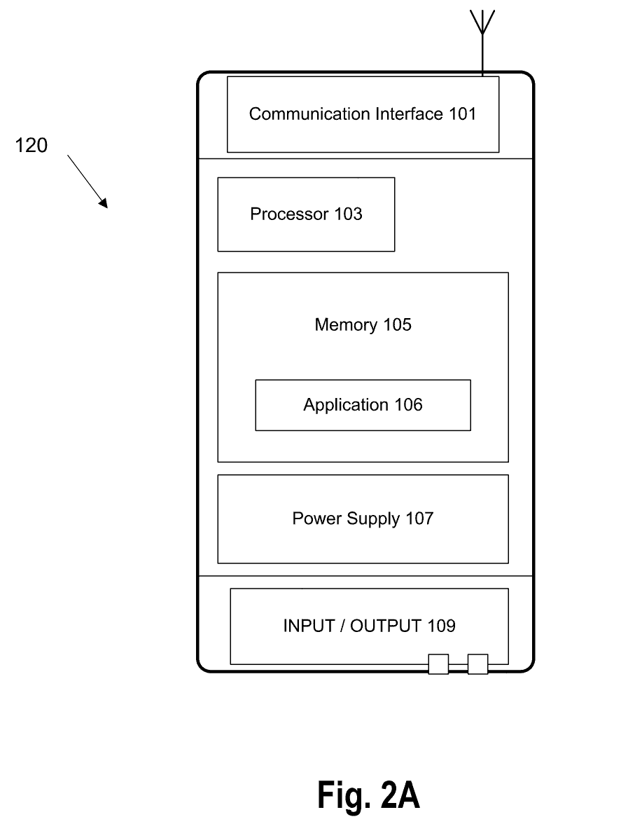

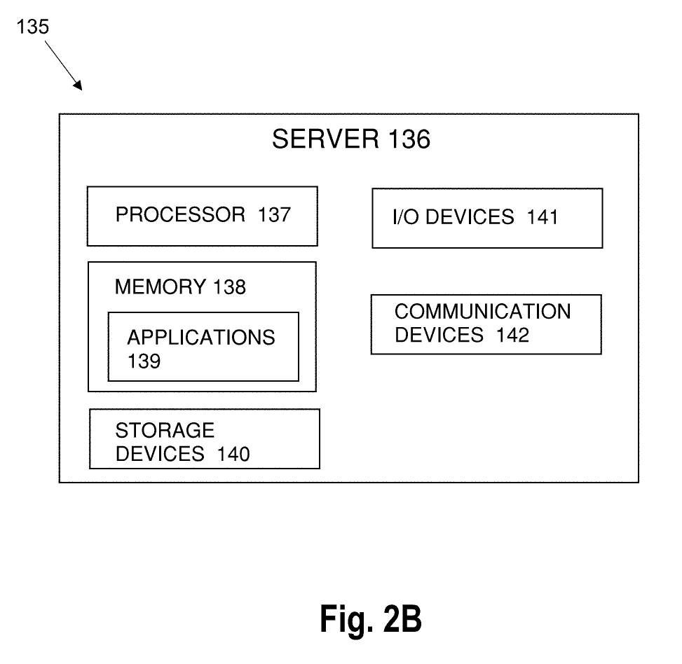

FIG. 2A shows a block diagram of a typical computing device 120 useable in conjunction with the system for assuring multilateral privacy 100. As depicted, the computing device 120 includes a communication interface 101, a processor 103, a power supply 107, and input/output 109. In an embodiment, the communication interface 101 controls various input/output devices including a digital camera, a connector port, a headphone jack, and a built-in speaker and microphone. In various embodiments, the communication interface 101 also includes a touchscreen. The processor 103 includes a central processing unit (CPU). The memory can include ROM/RAM, flash memory and the like. The power supply 109 can include a re-chargeable battery and power charger. Application 106 is stored in the memory 105, and includes program code non-transitorily embedded thereon. This program code includes various programs executable by the processor 103 to interface with the Trusted Authority 135, record video/audio, process text, encrypt data, and prompt the parties as to creating a digital object and collect pertinent information. In general, the application 106 will include the software of the invention to effect the “client-side” methods described herein. In some cases, the software will include software that comes with the computing device 120 or was installed previously, such as video or audio recording software.

FIG. 2B shows a block diagram of a typical computing system useable by the Trusted Authority 135. As shown, the Trusted Authority 135 has a “server” 136. The server 136 is programmed in accordance with the “server-side” methods described herein. The Trusted Authority 135 server 136 comprises a computer processor 137, memory (RAM, ROM, etc.) 138 (including memory for non-transitorily storing program code comprising applications 139), fixed and removable storage devices 140 (hard drive, memory stick, solid state drives, etc.), input/output devices 141 (keyboards, display monitors, pointing devices, printers, etc.), and communication devices 142 (Ethernet cards, WiFi cards, modems, etc.) Although the Internet 150 is depicted as being used for communication among the illustrated entities, it is to be understood that other network elements could, alternatively, or in addition, be used. These may include any combination of wide area networks, local area networks, public switched telephone networks, wireless or wired networks, intranets, or any other communication system.

The system for assuring multilateral privacy 100 includes a distributed application (106, 139) which is partitioned between a service provider (Trusted Authority 135) and a plurality of service requesters (computing devices 120). Under this arrangement, a request-response protocol, such as hypertext protocol (HTTP), can be employed such that a client (computing device 120) can initiate requests for services from the server 136 (Trusted Authority 135), and the server 136 can respond to each respective request by, for example, executing an application, and (where appropriate) sending results to the client (computing devices 120). The server 136 (Trusted Authority 135) can also include a database and a logic engine operatively linked to the server, allowing the application to query and store data therein. It is to be understood that in some embodiments, however, substantial portions of the application logic may be performed on the client using, for example, the AJAX (Asynchronous JavaScript and XML) paradigm to create an asynchronous web application. Furthermore, it is to be understood that in some embodiments the application can be distributed among a plurality of different servers (not shown).

In the following description of the present invention, exemplary methods for performing various aspects of the present invention are disclosed. It is to be understood that the steps illustrated herein can be performed by executing computer program code written in a variety of suitable programming languages, such as C, C++, C#, Visual Basic, and Java. It is also to be understood that the software of the invention will preferably further include various Web-based applications that can be written in HTML, PHP, Javascript, jQuery, etc., accessible by the clients (Trusted Authority 135) using a suitable browser 145 (e.g., Internet Explorer, Microsoft Edge, Mozilla Firefox, Google Chrome, Safari, Opera) or as an application running on a suitable mobile device (e.g., an iOS or Android “app”).

As a non-limiting example, Alice and Bob meet at a party, and agree to meet later at Bob's apartment so as to engage in sexual intercourse. While it is in their mutual interest to keep the act private, per social norms, it is also in each person's interest to ensure that they both behave per agreed norms, especially pertaining to each party's safety and well-being. To memorialize the agreement, Alice invokes an application 106 on her smartphone (computing device 120) that prompts (e.g., using an HTML form) the parties for information regarding sexual acts consented to, limits to those acts, and so forth. Alternately, or in addition, the parties, Alice and Bob, can video record statements regarding the proposed sexual acts and explain what each person consents to. In some cases the parties will not be able to agree. The agreement (or non-agreement) is time and date stamped.

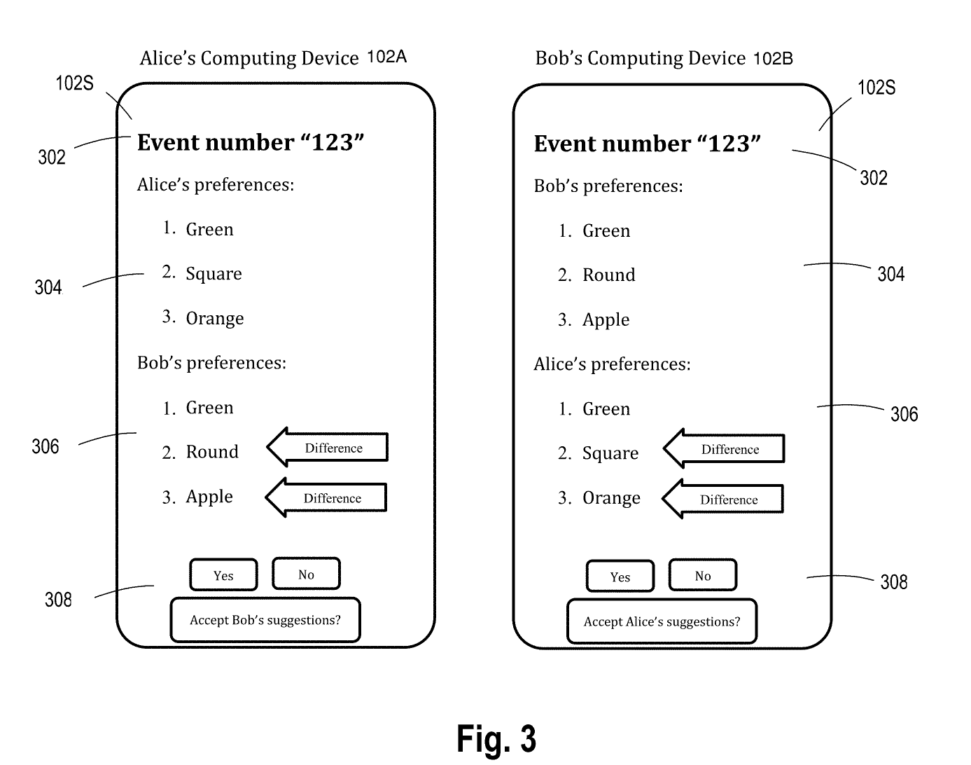

FIG. 3 illustrates an embodiment of the system for assuring multilateral privacy 100 that employs pre-condition matching. Pre-condition matching requires that both parties connect (e.g., login) to the server 136, and then identify the other party. Once both parties have identified each other, an event id 302 is assigned, and various default conditions and/or acceptable behavior (“preferences”) that have been previously supplied by the parties are retrieved from storage device 140. These default preferences are a way to enable a hassle-free agreement between the parties because it allows the system to check what the parties consent to without the need for prompts. However, if a party has a default profile that states a preference for rough play while the other party has a default profile that states preference for gentle cuddling, for example, this difference has to be reconciled before the parties are allowed to go forward, though that may not be possible since some preferences might be irreconcilable and in this case the parties are prompted to register disengagement.

As illustrated, a first computing device 102A (operated by Alice) and a second computing device 102B (operated by Bob) include respective screens 102S that display the retrieved preferences for each user, operatively under control of the application 106 and the server 136. As shown, Alice's computing device 102A includes a screen portion 304 that shows her preferences being “Green,” “Square, and “Orange,” and a screen portion 306 that shows Bob's preferences as being “Green,” “Round,” and “Apple.” Likewise, Bob's mobile device 102B includes a screen portion 304 that shows his preferences being “Green,” “Round, and “Apple” and a screen portion 306 that shows Alice's “preferences” as being “Green,” “Square, and “Orange.” It is to be understood that the illustrated preferences would actually include sexual preferences (e.g., cuddling, rough sex, oral sex), and that there could be greater or lesser than the number of preferences shown. It is to be further understood that the screens 102S could include scrollable portions, and that various graphical widgets (e.g., radio button, sliders, pull-down menus) could be used as well. Accordingly, it is to be understood that the shown embodiment is for illustrative purposes, and could be different in an actual implementation.

Continuing with the example, in this embodiment, the system 100 can match the preferences of Alice and Bob, and note any differences, using any suitable matching algorithm known in the art. As shown, for example, both

Alice and Bob agree on “Green” but do not match with respect to each other's other “default” preferences. As shown, the differences are highlighted using arrows with the text “Difference” pointing to each of the non-matching default preferences (though the same effect could be done in some other manner, such as using color highlighting, for example). In the illustrated example, Alice prefers “Square” and “Orange” but Bob prefers “Round” and “Apple.” Either party may accept the other party's preferences. For example, if Alice accepted Bob's preferences, she would select the “Yes” button in the reconciliation portion 308 of her device 102A. Likewise, if Bob accepted Alice's preferences, he would select the “Yes” button in the reconciliation portion 308 of his device 102B. Once a party accepts the other's preferences, an agreement is finalized as to the mutual preferences being the agreed upon preferences of the parties. As before, the parties are prompted for the conditions under which a third party may obtain access to the agreement and, in some cases the parties may select an arbiter. However, in some cases the parties will not be able to agree to mutual preferences. The agreement (or non-agreement) will be time- and date-stamped, and converted to an encrypted digital object, which is kept by the Trusted Authority 135. As before, the encrypted digital object will be decrypted only if both Alice and Bob consent thereto, or provided to third party if the conditions for such release are later met.

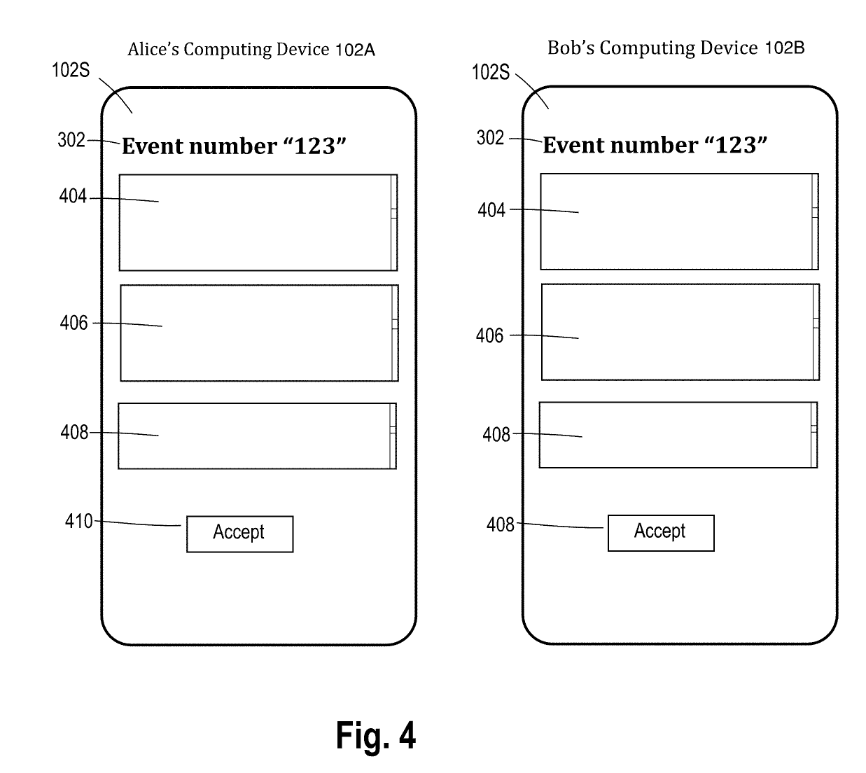

FIG. 4 illustrates an embodiment of the system for assuring multilateral privacy 100 that employs a technique for negotiated preference matching. Negotiated preference matching is similar to pre-condition matching except that this technique allows the parties to “haggle” regarding the agreed upon preferences. In this case, as before, Alice and Bob each have a computing device 102A-B, operating under control of the application 106 and the server 136. Using each respective computing device 102A-B, the parties are able to negotiate a set of mutually agreed upon preferences. As shown, Alice's screen 102S includes a personal preferences portion 404, another party preferences portion 406, a matching preferences portion 408, and an acceptance button 410. Similarly, Bob's screen 102S includes a personal preferences portion 404, another party preferences portion 406, a matching preferences portion 408, and an acceptance button 410. Each of the screen portions 404, 406, and 408 preferably will be a scrollable window. In the personal preferences portion 404 and the other party' s preferences 406 will be lists of possible preferences. Although the set of possible preferences can be quite large, the system also allows users to customize their list of personal preferences by inputting their own specific preferences. In operation, for example, the parties, Alice and Bob, might together discuss what they would like to do, and then each selects preferences on their respective personal preferences portions 404. Selection can be done, for example, by clicking a preference item from the list of personal preferences in the personal preferences portion 404, causing the selected preferences to be highlighted and information gathered for input to the server 136 regarding the selection. (It is to be understood that as before certain default preferences may optionally be listed as pre-selected on the party's respective personal preferences portion 404, with the option of the user to de-select the default preference.) As an example, Alice might select from a list of preferences “sexual intercourse with a condom,” “oral sex,” and “gentle play only” while Bob might select “sexual intercourse with a condom,” “oral sex,” and “moderately rough play (spanking).” In this case, Alice's other party's preferences portion 408 would show Bob's preferences, and Bob's other party's preferences portion 408 would show Alice's preferences. Both Alice's and Bob's matching preferences portion 408 would only show the preferences both parties have thus far agreed upon, namely, “sexual intercourse with a condom” and “oral sex”. In an embodiment, preferences not agreed upon could also be shown on the screens 102S of each of the parties. Because the parties do not entirely agree on preferences, the parties may wish to negotiate to reach full agreement. For example, Bob might acquiesce, and change his personal preference of “moderately rough play (spanking)” to “gentle play only.” Once negotiation has completed, the parties may accept the mutually agreed upon preferences indicated in the matching preferences portions 408 by each party selecting acceptance button 410. Once the acceptance button 408 is selected, the information provided by the user is submitted to the server 136 for processing.

The server 136 waits until the each device 102A-B submits an acceptance of the same matching preferences. If the server 136 determines there is acceptance by both parties, an agreement is indicated as being reached. In this case, such agreement reflects the negotiated mutual preferences. An encrypted digital object is created as before, along with the same procedures for decryption as mentioned above.

In various embodiments, the files that are created on Alice's computing device 120 are immediately encrypted using a public key generated and provided by the Trusted Authority 135; however, in other embodiments, the users are able to preview the “digital object” before it is encrypted. In the latter case, the preview allows the user to decide to encrypt the digital object or to create it again. In this case, the digital object is deleted, and the user is again provided with the means to create another such object. In an embodiment, the digital object is an encrypted “zip file” or the like. In an embodiment, the Trusted Authority 135 securely stores the encrypted digital object and will decrypt it and distribute it only at the request of both Alice and Bob or where a condition mutually agreed upon by Alice and Bob happens. Decryption occurs using a private key known by the Trusted Authority 135 but not Alice or Bob. If the digital object is encrypted, the decrypted information can be sent via a secured channel such as one using SSL or public key encryption wherein the public key generated by the receiver (Alice/Bob) is used by the sender (Trusted Authority 135) to encrypt and a private key known by the receiver is used to decrypt, for example.

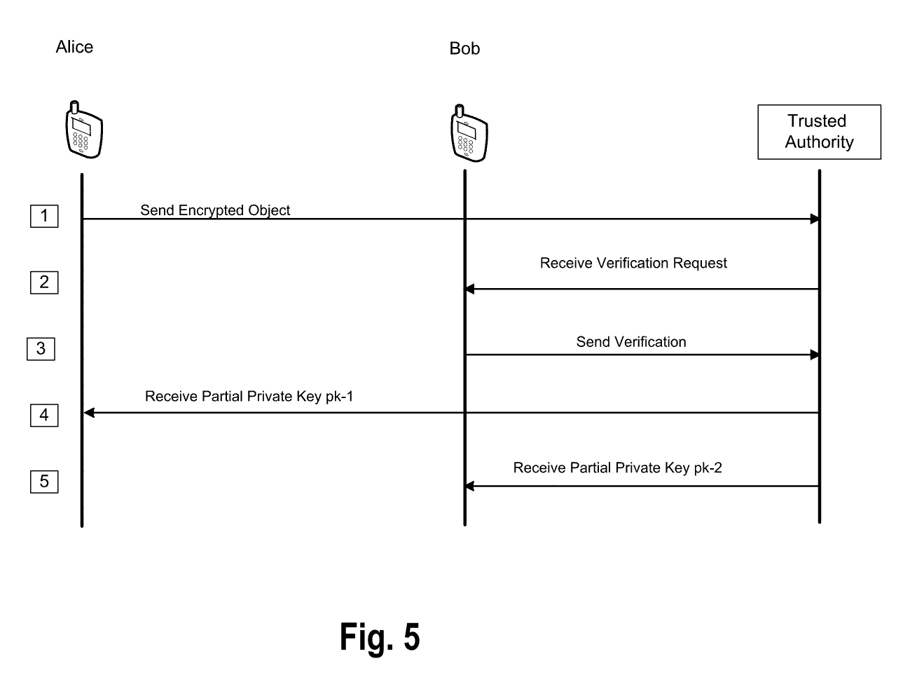

FIG. 5 illustrates an example process wherein a pair of individuals (Alice and Bob) are provided with partial private keys, both of which are necessary together to decrypt the encrypted digital object unless a predetermined condition is met, wherein a trusted authority may decrypt the encrypted digital object with its own private key. In an embodiment, the partial private keys are each the same length such that, for example, in a two-person agreement where the private key is 4,096 bits, each partial private key is 2,048 bits in length. In this embodiment, the first partial private key represents the first 2,048 bits of the private key and the second partial private key represents the second 2,048 bits. In other cases, the partial private keys are not of equal length. In other cases, there will be more than two parties to the agreement, so the partial private keys will have to be divided differently. However, when concatenated in the proper sequence, the partial private keys will form the whole private key.

In the instant embodiment, the digital object represents a two-person agreement created and encrypted as disclosed above. In Step 1, Alice sends the encrypted digital object along with other information obtained from the parties related to the agreement to the Trusted Authority 135 via the Internet. The Trusted Authority 135 sets up a record for the parties and stores the information preferably in a relational database. In Step 2, Bob receives a verification request from the Trusted Authority 135. The verification request includes information regarding the agreement, and asks that Bob verify that he has entered into the agreement with Alice. This verification request can be sent to Bob's application or as an email or text message, for example. In Step 3, Bob verifies the transaction by responding affirmatively to the verification request (e.g., clicking on a link or a button). Next, in Steps 4 and 5, respectively, Alice and Bob receive partial private keys. In the illustrated embodiment, the private key pk for decrypting the cyphertext is split into two portions, pk-1 and pk-2, each having a sequence and allowing the keys to be used as a single decryption key by concatenating the keys pk-1, pk-2 in the proper sequential order to form a private whole key pk. The Trusted Authority 135 also retains the whole private key pk. However, since there is a danger in sending even partial private keys via an unsecured channel, the pk-1 and pk-2 partial keys can be sent using public key encryption wherein a public key generated by each receiver (Alice/Bob) is used by the sender (Trusted Authority 135) to encrypt and a private key known by the receiver (Alice/Bob) is used to decrypt. Additional assurances known in the art may be used to ensure the identity of the sender depending on the degree of actual or perceived risk. Alternatively, the keys pk-1 and pk-2 could be sent to the Alice and Bob, respectively, via a disc or other external media via a mail or other such delivery service. Although the illustrated embodiment employs a simple method for providing splitting private keys that can only be used jointly, it is to be understood that other known or later developed cryptographic techniques to accomplish the essentially forgoing may suffice.

FIG. 5 illustrates an exemplary process by which Alice and Bob obtain a decrypted copy of the digital object. In Step 1, Alice sends her partial private key pk-1 along with a request to the Trusted Authority 135 for release of the digital object. Responsive to the request, in Step 2, the Trusted Authority 135 sends a request to Bob for consent to release the digital object. In Step 3, Bob sends consent to release the digital object along with his partial private key pk-2 to the Trusted Authority 135. At this point, the Trusted Authority now has the necessary consents, so then decrypts the digital object by concatenating the pk-1 and pk-2 pair in the proper sequential order. The sequential order may be already known to the Trusted Authority 135 or may be provided in a metadata field, for example. In Step 4, Alice receives the requested decrypted digital object from the Trusted Authority 135. In Step 5, Bob similarly receives a copy of the decrypted digital object from the Trusted Authority 135. In Steps 4 and 5, the decrypted digital object can be sent via SSL or by using public encryption wherein the public key generated by the receiver is used by the sender to encrypt and a private key known by the receiver is used to decrypt, for example. In the instant embodiment, Alice and Bob both provide their private keys pk-1 and pk-2, respectively, to the Trusted Authority 135 for decryption purposes. In other embodiments, Alice and Bob merely provide identification information to the Trusted Authority 135 which decrypts the digital object using the private key pk that it already has. In still other embodiments, Alice and Bob can decrypt the digital object locally using the keys pk-1 and pk-2 that they already have using a computing device 120 with appropriate decryption software.

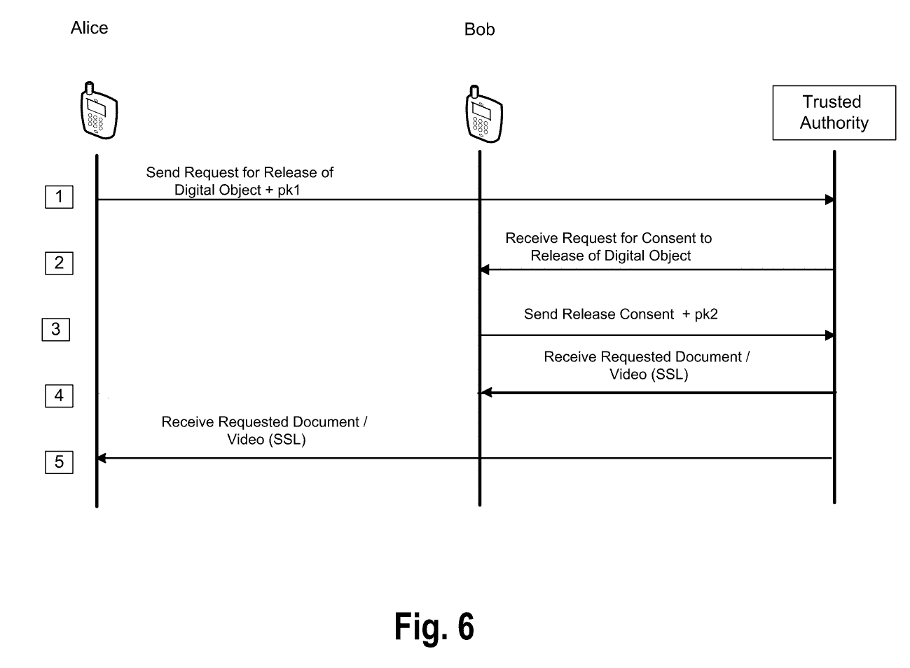

FIG. 6 illustrates an exemplary process by which Trusted Authority 135 decrypts the encrypted digital object for a 3^{rd} Party Requestor. In Step 1, a request for release of the digital object is received by the Trusted Authority 135. Trusted Authority 135 will have information as to the predetermined condition(s) for release of such information. As an example, the condition could include a situation where a criminal investigation against Bob has been instituted or a subpoena in a civil case has been issued for discovery of information relevant to the case. In other cases, the parties will allow an arbiter to make the request at his or her own discretion without Alice or Bob necessarily agreeing thereto. Once the request is received by the Trusted Authority 135, in Step 2, the Trusted Authority may ask for additional information to verify the 3^{rd} Party's authority. In Step 3, the 3^{rd} Party Requestor sends the verification information to the Trusted Authority 135. Once the verification information is processed and it is determined that the 3^{rd} Party Requestor has the proper authority for release of the digital object, the digital object is decrypted using the private key pk held by the Trusted Authority 135. In Step 5, the decrypted digital object is sent to the 3^{rd} Party Requestor. The manner in which this secure data is delivered to the 3^{rd} Party Requestor will be keeping with how the relevant jurisdiction requires such secure information to turned over to a requestor, such as the manner in which confidential information is delivered to the District Attorney or to a lawyer requesting such information in a civil case or for an arbitration hearing.

In the example used above, Alice and Bob enter into a private agreement relating to sexual intercourse. However, it is to be understood that the present invention is not limited to such cases but can be used for many other situations where parties to an agreement would like to keep an agreement in private, but also maintain the possibility of disclosure. This is particularly true whenever the parties to an agreement would like to forgo the bureaucracy of a formal contract involving lawyers and courts, such as in the preliminary stages of a negotiation. For example, a party may agree to sell a product to another party for a certain price, provided the first party does not find a better deal elsewhere during a time window. During this time window it will not be in the parties' interest that others know of the price agreed upon. As another example, two individuals competing for a promotion within their team agree that, if one of them is chosen, the other will be nominated deputy. If there is a dispute as to the agreement, the agreement could be made public. As yet another example, when splitting an inheritance, a child and a parent agree on who shall receive a certain item of sentimental value, but the parent does not want to deal with the possibility of others objecting. Although the will is the legal instrument to stipulate the bequest, the reasoning for such bequest can help soothe bad feelings later and even establish that the testator was of lucid mind regarding the bequest if the will is questioned or formally contested. In each of these cases, according to the systems and methods of the present invention, the private agreement could be decrypted and should later decryption prove necessary, it may be done by consent of parties or it may be done unilaterally by an arbitrating party, following procedures applicable to their respective jurisdictions.

It is to be understood that although two parties (e.g., Alice and Bob) are disclosed entering into an agreement, more than two parties can be parties to an agreement as this term is used herein. Where there are more than two parties, all of the parties will still have to provide consent for the digital object to be decrypted unless the condition agreed upon by all of the parties occurs, in which case the Trusted Authority 135 will decrypt the digital object. Accordingly, it is to be understood that the present invention is not limited to a two-person agreement. Finally, while the term “person” and “party” is used herein, it is to be understood that such usage is not meant to be limited to natural persons, and includes various legally-formed entities, e.g., corporations, partnerships, limited liability corporations, as well as informal associations and joint ventures.

While this invention has been described in conjunction with the various exemplary embodiments outlined above, it is evident that many alternatives, modifications and variations will be apparent to those skilled in the art. Accordingly, the exemplary embodiments of the invention, as set forth above, are intended to be illustrative, not limiting. Various changes may be made without departing from the spirit and scope of the invention.

What is claimed is:

1. A method for assuring multilateral privacy, comprising:
encrypting a digital object representing a private agreement between parties to an agreement;
storing the encrypted digital object; and
decrypting the stored encrypted object;
wherein the decrypting step is performed only if all of the parties agree to the decryption or a set of predetermined conditions is met.

2. The method of claim 1, wherein if the set of predetermined conditions is met and the digital object is thereupon decrypted, the decrypted digital object is provided to a third party.

3. The method of claim 1, wherein the encrypting is done using a public key, and the decryption is done using a private key.

4. The method of claim 1, wherein the decryption is done by a trusted authority using a private key.

5. The method of claim 1, wherein the decrypting step involves use of private keys including a set of private keys that are capable of decrypting the encrypted digital object only if used concomitantly.

6. The method of claim 5, wherein the set of private keys includes a private key useable only by a trusted authority when a predetermined condition is met capable of decrypting the encrypted digital object.

7. The method of claim 1, wherein the digital object includes one or more object recorded using the computing device.

8. The method of claim 1, wherein the digital object includes one or more of a text document, an audio recording, and a video recording, and combinations thereof.

9. The method of claim 5, wherein each of the parties is provided a partial private key by a trusted authority useable together to decrypt the digital object.

10. The method of claim 9, wherein the partial private keys have a sequence and can be used to decrypt the encrypted digital object by concatenating the partial private keys in the sequence.

11. The method of claim 1, wherein a trusted authority has a server and storage configured to receive and effect storage of a copy of the encrypted digital object.

12. The method of claim 11, further comprising the server being configured to receive information related to the private agreement.

13. The method of claim 12, wherein the information related to the private agreement includes location of the digital object, selection of a third party authority, and the predetermined condition to allow the third party authority to decrypt the encrypted digital object.

14. The method of claim 1, wherein the private agreement is an agreement regarding a planned sexual encounter between the parties.

15. The method of claim 1, wherein the set of predetermined conditions includes a court order requiring decryption of the encrypted digital object.

16. The system of claim 1, wherein the set of predetermined conditions includes one or more of a subpoena, a discovery request, and an agreed-upon condition by the parties to the private agreement.

17. The method of claim 1, wherein the agreement is reached using an application program executed on each of the party's computing device, the application program reconciling preferences of the parties.

18. The method of claim 17, wherein the reconciliation employs pre-condition preference matching.

19. The method of claim 17, wherein the reconciliation employs negotiated preference matching.

20. The system of claim 1, wherein the computing device is one or more of a smartphone, a tablet computer, a laptop computer, and a desktop computer.
